(19) United States
(12) Patent Application Publication
(10) Pub. No.: US 2026/0264565 A1
(43) Pub. Date: Sep. 10, 2026

(54) APPARATUS AND METHOD FOR CONTROLLING TEMPERATURE OF COOLANT IN FUEL CELL STACK

(71) Applicants: Hyundai Motor Company, Seoul (KR); Kia Corporation, Seoul (KR)

(72) Inventors: Jeong Woo Park, Hwaseong-Si (KR); Jae Hun Jang, Hwaseong-Si (KR); Hwan Hui You, Hwaseong-Si (KR); Young Pin Jin, Hwaseong-Si (KR); Jae Won Jang, Hwaseong-Si (KR)

(21) Appl. No.: 19/304,246

(22) Filed: Aug. 19, 2025

(30) Foreign Application Priority Data
Mar. 4, 2025 (KR) 10-2025-0027269

(51) Int. Cl. B60L 58/12; B60L 58/31; B60L 58/33; B60L 58/34

(52) U.S. Cl. CPC B60L 58/12; B60L 58/31; B60L 58/33; B60L 58/34

(57) ABSTRACT

An apparatus of a vehicle may comprise a fuel cell stack, a processor, and a memory storing at least one instruction. When executed by the processor communicating with the memory, the instruction is configured to cause the apparatus to, after an ignition of the vehicle equipped with the fuel cell stack is off, determine, based on a state of charge (SOC) of a battery mounted on the vehicle and a temperature of a coolant in the fuel cell stack, one of a plurality of temperature increase modes of the fuel cell stack, wherein the plurality of temperature increase modes comprise a mode using a cathode oxygen depletion (COD) heater and a mode not using the COD heater, and control, based on the determined mode, the temperature of the coolant in the fuel cell stack.

### CROSS-REFERENCE TO RELATED APPLICATION

The present application claims the benefit of priority to Korean Patent Application No. 10-2025-0027269, filed in the Korean Intellectual Property Office on Mar. 4, 2025, the entire contents of which are incorporated herein for all purposes by reference.

### TECHNICAL FIELD

The present disclosure relates to an apparatus and method for controlling the temperature of a coolant in a fuel cell stack, wherein the apparatus and method are capable of reducing the use amount of a cathode oxygen depletion (COD) heater to prevent deterioration in a temperature increase process of the fuel cell stack.

### BACKGROUND

The matters described in this Background section are only for enhancement of understanding of the background of the disclosure, and should not be taken as acknowledgment that they correspond to prior art already known to those skilled in the art.

A fuel cell is a system to convert chemical energy into electric energy by using the oxidation-reduction reaction of hydrogen and oxygen supplied from a hydrogen supply system and an oxygen supply system, respectively. The fuel cell may include a fuel cell stack that produces electric energy and a cooling apparatus for cooling the fuel cell stack.

As hydrogen is supplied to the anode of the fuel cell stack, an oxidation reaction of the hydrogen is initiated on the anode, thereby producing hydrogen ions (protons) and electrons. The hydrogen ions and electrons produced thereby are moved to the cathode through an electrolyte membrane and a separator. Then, water is produced on the cathode through an electrochemical reaction between the hydrogen ions and electrons moved from the anode and oxygen in the air, and the electric energy is finally generated from the currency of such electrons.

Once a fuel cell stack is driven, it is one of the important issues that the generated water on the anode and cathode is appropriately discharged. The phenomenon in which excessive generated water accumulates and interferes with the normal operation of the fuel cell stack is called flooding. By suppressing the occurrence of the flooding in the fuel cell stack as much as possible and maintaining appropriate amount of moisture in the fuel cell stack, the performance, durability, and efficiency of the fuel cell stack may be increased or maximized.

After an ignition of a mobility (vehicle, drone, etc.) equipped with a fuel cell stack is off, a cold shut down (CSD) control may be performed to remove generated water in the fuel cell stack. The CSD control is a process of discharging water or wet gas, generated in the process of supplying hydrogen and air to the fuel cell stack and purging the supplied hydrogen, into the atmosphere to prevent freezing of the fuel cell stack. However, before performing the CSD control, a COD heater is operated to increase the temperature of the coolant, but there may be a problem that the durability of the COD heater is weakened due to the frequent operation of the COD heater. Moreover, the power required for the fuel cell stack to operate the COD heater may increase, deteriorating the durability of the fuel cell stack.

### SUMMARY

Various examples of the present disclosure are directed to providing an apparatus and method for controlling the temperature of a coolant in a fuel cell stack, wherein the apparatus and method are capable of controlling the temperature of the fuel cell stack while reducing the use amount of a COD heater to prevent deterioration of the durability of the fuel cell stack and the COD heater during a temperature increase process of the fuel cell stack performed prior to a cold shut down (CSD) of the fuel cell stack.

Various examples of the present disclosure are directed to providing an apparatus and method for controlling the temperature of a coolant in a fuel cell stack, wherein the apparatus and method are capable of performing different temperature increase modes depending on the current coolant temperature and battery’s state of charge (SOC) so as to match a time point if the coolant temperature reaches a target value with a time point when the battery’s SOC reaches a target value.

According to the present disclosure, an apparatus of a vehicle, the apparatus may comprise a fuel cell stack, a processor, and a memory storing at least one instruction that, when executed by the processor communicating with the memory, is configured to cause the apparatus to after an ignition of the vehicle equipped with the fuel cell stack is off, determine, based on a state of charge (SOC) of a battery mounted on the vehicle and a temperature of a coolant in the fuel cell stack, one of a plurality of temperature increase modes of the fuel cell stack, wherein the plurality of temperature increase modes comprise a mode using a cathode oxygen depletion (COD) heater and a mode not using the COD heater, and control, based on the determined one of the plurality of temperature increase modes, the temperature of the coolant in the fuel cell stack.

The at least one instruction, when executed by the processor communicating with the memory, may be configured to cause the apparatus to determine one of the plurality of temperature increase modes by comparing a ratio of a temperature increase demand to a charge demand with a set range, wherein the temperature increase demand is a difference between the temperature of the coolant and a target temperature, and wherein the charge demand is a difference between the SOC of the battery and a target SOC.

The at least one instruction, when executed by the processor communicating with the memory, may be configured to cause the apparatus to determine one of the plurality of temperature increase modes as a first mode based on the ratio of the temperature increase demand to the charge demand being less than a lower boundary of the set range, determine one of the plurality of temperature increase modes as a second mode based on the ratio of the temperature increase demand to the charge demand being within the set range, and determine one of the plurality of temperature increase modes as a third mode based on the ratio of the temperature increase demand to the charge demand being greater than an upper boundary of the set range.

In the first mode, the at least one instruction, when executed by the processor communicating with the memory, may be configured to cause the apparatus to stand by until the ratio of the temperature increase demand to the charge demand enters the set range, before operating the fuel cell stack.

The at least one instruction, when executed by the processor communicating with the memory, may be configured to cause the apparatus to determine whether the ratio of the temperature increase demand to the charge demand enters the set range every time a wake-up of the vehicle occurs, and operate the fuel cell stack based on the ratio of the temperature increase demand to the charge demand entering the set range.

In the second mode, the at least one instruction, when executed by the processor communicating with the memory, may be configured to cause the apparatus to operate the fuel cell stack to increase the temperature of the coolant, and charge the battery.

In the third mode, the at least one instruction, when executed by the processor communicating with the memory, may be configured to cause the apparatus to operate the COD heater, before operating the fuel cell stack, to increase the temperature of the coolant.

The apparatus, wherein, based on the ratio of the temperature increase demand to the charge demand entering the set range, the at least one instruction, when executed by the processor communicating with the memory, is configured to cause the apparatus to stop operating the COD heater, and operate the fuel cell stack.

The at least one instruction, when executed by the processor communicating with the memory, may be configured to cause the apparatus to compare a charge demand energy with a temperature increase demand energy to determine one of the plurality of temperature increase modes in which a timing of operating the fuel cell stack varies, wherein the charge demand energy is an energy used to charge the battery until the SOC of the battery reaches a target SOC, wherein the temperature increase demand energy is an energy used to increase the temperature of the coolant until the temperature of the coolant reaches a target temperature, and wherein the temperature increase demand energy is a product of a temperature increase demand and a heat capacity of the coolant, wherein the temperature increase demand is a difference between the temperature of the coolant and the target temperature, and wherein the heat capacity of the coolant varies based on outside temperature of the fuel cell stack.

According to the present disclosure, a vehicle may comprise a fuel cell stack configured to generate power, a battery configured to be charged by the power generated by the fuel cell stack, a processor, and a memory storing at least one instruction that, when executed by the processor communicating with the memory, is configured to cause the vehicle to after an ignition of the vehicle is off, determine, based on a state of charge (SOC) of the battery and a temperature of a coolant in the fuel cell stack, one of a plurality of temperature increase modes of the fuel cell stack, wherein the temperature increase modes comprise a first mode of waiting until a wake-up of the vehicle, a second mode of operating the fuel cell stack, and a third mode of operating a cathode oxygen depletion (COD) heater, and control, based on the determined one of the plurality of temperature increase modes, the temperature of the coolant in the fuel cell stack.

The at least one instruction, when executed by the processor communicating with the memory, may be configured to cause the vehicle to control, based on the determined one of the plurality of temperature increase modes, the temperature of the coolant in the fuel cell stack before a cold shut down (CSD) control in which air is supplied to discharge droplets remaining in the fuel cell stack.

The at least one instruction, when executed by the processor communicating with the memory, may be configured to cause the vehicle to determine one of the temperature increase modes by comparing a ratio of a temperature increase demand to a charge demand with a set range, wherein the temperature increase demand is a difference between the temperature of the coolant and a target temperature, and wherein the charge demand is a difference between the SOC of the battery and a target SOC, in the first mode, operate the fuel cell stack based on the ratio of the temperature increase demand to the charge demand entering the set range, and in the third mode, stop operating the COD heater and operate the fuel cell stack based on the ratio of the temperature increase demand to the charge demand entering the set range.

The at least one instruction, when executed by the processor communicating with the memory, may be configured to cause the vehicle to operate the fuel cell stack at an output level that varies based on the SOC of the battery and the temperature of the coolant.

According to the present disclosure, a method performed by an apparatus of a vehicle, the method may comprise obtaining information about a state of charge (SOC) of a battery of the vehicle and a temperature of a coolant in a fuel cell stack of the vehicle after an ignition of the vehicle is off, determining, based on the information about the SOC of the battery and the temperature of the coolant in the fuel cell stack, one of a plurality of temperature increase modes of the fuel cell stack, and based on the determining of the one of the plurality of temperature increase modes, performing one of operating the fuel cell stack, or standing by without operating the fuel cell stack and a cathode oxygen depletion (COD) heater until a wake-up of the vehicle.

The determining of one of the plurality of temperature increase modes of the fuel cell stack may comprise determining one of the plurality of temperature increase modes based on whether a ratio of a temperature increase demand to a charge demand falling within a set range, wherein the temperature increase demand is a difference between a temperature of a coolant and a target temperature, and wherein the charge demand is a difference between a SOC of the battery and a target SOC.

The plurality of temperature increase modes may comprise a first mode in which, based on the ratio of the temperature increase demand to the charge demand being less than a lower boundary of the set range, waiting is performed without operating the fuel cell stack and the COD heater until the ratio of the temperature increase demand to the charge demand reaches the set range.

The plurality of temperature increase modes may comprise a second mode in which, based on the ratio of the temperature increase demand to the charge demand being within the set range, operating the fuel cell stack and operating the COD heater are performed without delay after the ignition of the vehicle is off.

The plurality of temperature increase modes may comprise a third mode in which, based on the ratio of the temperature increase demand to the charge demand being greater than an upper boundary of the set range, the COD heater is operated until the ratio of the temperature increase demand to the charge demand reaches the set range.

In the third mode driving the COD heater is performed after a first wake-up of the vehicle, and based on the ratio of the temperature increase demand to the charge demand reaching the set range, the COD heater is stopped and the fuel cell stack is operated.

The plurality of temperature increase modes may comprise a mode of operating the fuel cell stack without delay after the ignition of the vehicle is off, and a mode of operating the fuel cell stack after a wake-up of the vehicle, wherein the mode of driving the fuel cell stack after the wake-up of the vehicle may comprise a mode of operating the COD heater and a mode of not operating the COD heater.

The methods and apparatuses of the present disclosure have other features and advantages which will be apparent from or are set forth in more detail in the accompanying drawings, which are incorporated herein, and the following Detailed Description, which together serve to explain certain principles of the present disclosure. The above and other features of the present disclosure are discussed infra.

### BRIEF DESCRIPTION OF THE DRAWINGS

FIG. 1 shows an example of an apparatus for controlling the temperature of a coolant in a fuel cell stack according to an example of the present disclosure;

FIG. 2 shows an example of how to determine the temperature increase modes of a fuel cell stack according to an example of the present disclosure;

FIG. 3 shows an example of a control method in a first mode according to an example of the present disclosure;

FIG. 4 shows an example of a control method in a second mode according to an example of the present disclosure;

FIG. 5 shows an example of a control method in a third mode according to an example of the present disclosure; and

FIG. 6 shows an example of a method for controlling the temperature of a coolant in a fuel cell stack according to an example of the present disclosure.

FIG. 7 shows an example computing system (e.g., a computing device of a fuel cell system, a processor, a vehicle, any other apparatus)

It should be understood that the appended drawings are not necessarily to scale, presenting a somewhat simplified representation of various exemplary features illustrative of the basic principles of the present disclosure. The predetermined design features of the present disclosure, including, for example, predetermined dimensions, orientations, locations, and shapes, will be determined in part by the particular intended application and usage environment.

In the figures, the reference numerals refer to the same or equivalent portions of the present disclosure throughout the several figures of the drawing.

### DETAILED DESCRIPTION

Hereinafter reference will now be made in detail to various examples of the present disclosure, examples of which are illustrated in the accompanying drawings and described below. However, the present disclosure may be embodied in various forms, and should not be construed as being limited to the examples set forth herein. Rather, the examples are provided so that the present disclosure will be thorough and complete, and will fully convey the scope of the present disclosure to those skilled in the art. The present disclosure is defined only by the categories of the claims. Wherever possible, the same reference numerals will be used throughout the drawings to refer to the same or like portions.

It will be understood that, although the terms “first”, “second”, etc. may be used herein to describe various similar elements, these elements should not be construed as being limited by these terms. These terms are only used to distinguish one element from another.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

The detailed description is merely illustrative of the present disclosure. Furthermore, the above description shows and describes examples of the present disclosure, but the present disclosure may be used in various other combinations, modifications, and environments. In other words, changes or modifications are possible within the scope of the idea of the present disclosure included herein, the scope equivalent to the described disclosure, and/or the scope of skill or knowledge in the art. The examples describe the best state for implementing the technical idea of the present disclosure, and various changes required for specific application fields and utilizes of the present disclosure are possible. Therefore, the detailed description of the present disclosure is not intended to limit the present disclosure to the disclosed examples of the present disclosure. Also, the appended claims should be construed to include other examples.

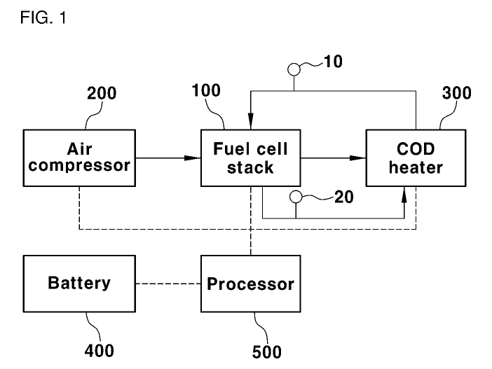

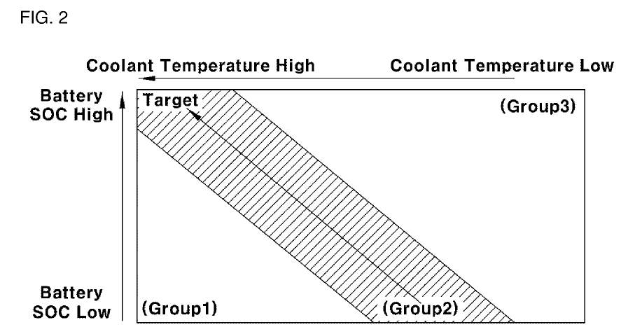

FIG. 1 shows an example of an apparatus for controlling the temperature of a coolant in a fuel cell stack according to an example of the present disclosure. FIG. 2 shows an example of how to determine the temperature increase modes of a fuel cell stack according to an example of the present disclosure.

Referring to FIGS. 1 and 2, an apparatus for controlling the temperature of a coolant in a fuel cell stack (hereinafter, “coolant temperature control apparatus”) may be implemented by a fuel cell stack 100, an air compressor 200, a cathode oxygen depletion (COD) heater 300, a battery 400, and a processor 500. The coolant temperature control apparatus is configured to control the temperature increase of the fuel cell stack 100 performed before a cold shut down (CSD) control, in which air is supplied to discharge droplets, such as generated water remaining in the fuel cell stack 100, after the ignition off (KEY OFF) of a vehicle. For example, the vehicle may include a commercial vehicle, a passenger vehicle, a work vehicle, a drone, an unmanned aerial vehicle (UAV), and an urban air vehicle (UAM) (e.g., a taxi drone, a cargo UAV, a delivery robot, or an off-road utility vehicle, etc.). The vehicle equipped with the coolant temperature control apparatus comprising the fuel cell stack 100 may include a motor configured to provide driving force using power supplied by the battery 400. The CSD control may be a process of discharging water or wet gas inside the fuel cell stack 100, generated in the process of supplying hydrogen and/or air to the fuel cell stack 100 and purging the supplied hydrogen, into the atmosphere to prevent freezing of the fuel cell stack 100. For this reason, controlling of the temperature of the fuel cell stack 100 before the CSD control may be performed in a situation where the ambient temperature is low (e.g., during overnight parking in winter, high-altitude operation, or prolonged vehicle inactivity in sub-zero climates, etc.), which may cause freezing of the generated water inside the fuel cell stack 100. To increase the temperature of the fuel cell stack 100 or coolant before performing the CSD control, the coolant temperature control apparatus may drive the fuel cell stack 100 or may drive the COD heater 300. By increasing the temperature of the fuel cell stack 100 or coolant before performing the CSD control, freezing of residual droplets in the fuel cell stack 100 may be prevented, and such droplets in the fuel cell stack 100 may be removed by the CSD control.

The fuel cell stack 100 may generate electricity through a chemical reaction by receiving air and hydrogen. To dissipate heat generated as a byproduct of the chemical reaction in the fuel cell stack 100, the coolant may circulate through the fuel cell stack 100.

The air compressor 200 may supply outside air to the cathode of the fuel cell stack 100. In the process of CSD control, residual droplets inside the fuel cell stack 100 may be removed by the air provided by the air compressor 200.

The COD heater 300 may consume power generated from the fuel cell stack 100 to increase the temperature of the coolant when the coolant temperature needs to be increased, or to decrease the voltage of the fuel cell stack 100. The COD heater 300 may be driven using power supplied from the fuel cell stack 100 or from power stored in the battery 400. Coolant discharged from the fuel cell stack 100 may be introduced into the COD heater 300, and coolant heated by the COD heater 300 may circulate through the fuel cell stack 100. Power generated by the operation of the fuel cell stack 100 may be supplied to the battery 400 to charge the battery 400. During the process of increasing the temperature of the fuel cell stack 100, a state of charge (SOC) of the battery 400 may be increased.

The processor 500 may include a fuel cell control unit (FCU) configured to control the fuel cell stack 100. The processor 500 may be composed of one or more cores and may include various types of processor circuit for data analysis and deep learning, such as a central processing unit (CPU), a general purpose graphics processing unit (GPGPU), a tensor processing unit (TPU), and an application processor (AP) of a computing device. One or more processors 500 may be controlled to process input data according to predetermined operation rules or artificial intelligence models stored in a memory. In a case where one or more processors 500 are artificial intelligence-dedicated processors, the artificial intelligence-dedicated processor may be implemented using a hardware architecture specifically designed for artificial intelligence model processing.

The processor 500 may read a computer program or command stored in a memory to perform controlling of the temperature of the coolant in the fuel cell stack according to the present example. The coolant temperature control apparatus may include a memory. The memory may store various information and maps needed in controlling the temperature of the coolant in the fuel cell stack according to the present example. The memory may include at least one type of storage medium among a flash memory type, a hard disk type, a multimedia card micro type, a card type memory (e.g., an SD card or XD card, CompactFlash, etc.), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. Moreover, the memory may include any type of computer-readable recording medium well known in the technical field to which the present disclosure belongs. The description of the above-mentioned memory is merely an example, and the present disclosure is not limited thereto.

Prior to CSD control, the processor 500 may determine temperature increase modes for increasing the temperature of the fuel cell stack 100. The processor 500 may choose one from a plurality of temperature increase modes by comparing the SOC of the battery 400 with the temperature of the coolant in the fuel cell stack 100. The temperature increase modes may include one or more modes (e.g., a mode using the COD heater 300, a mode that excludes use of the COD heater 300). For example, a mode excluding use of the COD heater 300 may rely solely on fuel cell stack operation, passive heat retention, or battery-based preheating, etc. Moreover, the temperature increase modes may include a mode of immediately driving the fuel cell stack 100 and a mode of waiting without operating either the fuel cell stack 100 or the COD heater 300 until a wake-up of the vehicle. The processor 500 may operate the COD heater 300 only in limited situations. When the COD heater 300 is used to increase the temperature of the coolant, such may cause the fuel cell stack 100 to operate at a voltage level that accelerates deterioration of the fuel cell stack . Here, because deterioration of the durability of the fuel cell stack 100 is expected, the processor 500 may drive the COD heater 300 in limited situations (e.g., to reduce degradation risk, the processor 500 may restrict activation of the COD heater 300 to specific cases.). For example, the potential at which deterioration of the fuel cell stack 100 is accelerated may be 0.7 V, and if the cell voltage of the fuel cell stack 100 drops below 0.7 V, there may be a possibility of accelerated deterioration (e.g., reduced stack lifetime, performance loss, or increased hydrogen consumption, etc.). Because the cell voltage of the fuel cell stack 100 may drop below 0.7 V when the COD heater 300 is driven, the COD heater 300 may not be driven in order to prevent accelerated deterioration of the fuel cell stack 100 except for limited situations (e.g., when the coolant temperature is critically low, when the vehicle is parked in extremely cold environments for extended durations, when passive or stack-based heating is insufficient to reach a minimum operating temperature for CSD, or when battery SOC is too high to justify further charging via stack operation, etc.). After the ignition of the vehicle is off, the processor 500 may analyze the SOC of the battery 400 and the temperature of the coolant in the fuel cell stack 100. The temperature of the coolant in the fuel cell stack 100 may be obtained from one or more temperature sensors (e.g., an inlet temperature sensor 10, an outlet temperature sensor 20, or both, etc.). The SOC of the battery 400 may be obtained from a battery management system (BMS) configured to manage the battery 400 (e.g., by monitoring voltage, current, and temperature conditions, etc.). When the processor 500 determines that the temperature increase mode is a mode in which immediate driving of the fuel cell stack 100 is needed, the processor 500 may drive the fuel cell stack 100 after the ignition of the vehicle is off but before a first wake-up occurs. However, in a case where the temperature increase process of the fuel cell stack 100 is not completed after the ignition of the vehicle is off, the processor 500 may perform the temperature control of the fuel cell stack 100 again in a state where the processor 500 is re-activated after a subsequent wake-up occurs. A wake-up corresponds to a condition in which the processor 500 is repeatedly activated at regular intervals. The time for which the processor 500 is activated after the wake-up may be determined in advance. The time for which the processor 500 is activated may be shorter than a cycle of the wake-up.

The processor 500 may choose one from the plurality of temperature increase modes. As an example, the processor 500 may determine one of the temperature increase modes depending on whether a ratio of a temperature increase demand, which is a difference between the coolant temperature and a target temperature, to a charge demand, which is a difference between the SOC of the battery 400 and a target SOC, is within a set range. The set range may be determined based on a value obtained by dividing the energy used to increase the temperature of the coolant by 1℃ by the energy used to increase the SOC of the battery 400 by 1%. The energy used to increase the temperature of the coolant by 1℃ may be the heat capacity of the coolant. The energy used to increase the temperature of the coolant by 1℃ may change depending on the outside temperature. For example, when the outside temperature is -30℃, the energy used to increase the temperature of the coolant by 1℃ may be approximately 70 KJ, and when the outside temperature is room temperature (e.g., 20℃ to 25℃), the energy used to increase the temperature of the coolant by 1℃ may be approximately 55 KJ. In other words, as the outside temperature rises, the energy used to increase the temperature of the coolant by 1℃ may decrease.

For example, the energy used to increase the SOC of the battery 400 by 1% may be approximately 95 KJ, and the energy used to increase the SOC of the battery 400 by 1% may not vary significantly based on the current SOC of the battery 400. Rather, the energy used to increase the SOC of the battery 400 by 1% may change based on the outside temperature (e.g., due to changes in battery efficiency at cold temperatures, etc.). Depending on the outside temperature, the energy used to increase the SOC of the battery 400 by 1% and the energy used to increase the temperature of the coolant by 1℃ may be stored as a map (e.g., a lookup table indexed by ambient temperature or historical energy profiles, etc.). The set range may be determined by applying a margin value set by a designer. In conclusion, the set range may be determined by applying a margin value predetermined based on the value obtained by dividing the energy used to increase the temperature of the coolant by 1℃ by the energy used to increase the SOC of the battery 400 by 1%. For example, if the energy used to increase the temperature of the coolant by 5℃ is similar to the energy used to increase the SOC of the battery 400 by 4%, then the set range may be determined, based on 1.25, as a value greater than 1.07 and smaller than 1.875 by applying a temperature margin value of 5℃ and an SOC margin value of 10%. When the SOC margin value of 10% (approximately 950 KJ) is applied, the temperature of the coolant may be further increased by approximately 12.5℃, and when the coolant temperature margin value of 5℃ (approximately 350 KJ) is applied, the SOC of the battery 400 may be correspondingly increased by approximately 4%. The range of Group 2 in FIG. 2 may be determined by applying the SOC margin value and the temperature margin value. However, the set range may be changed by the designer. Moreover, because the energy used to increase the temperature of the coolant by 1℃ and the energy used to increase the SOC of the battery 400 by 1% change based on the outside temperature (e.g., colder environments requiring more energy due to greater losses), the set range may also change based on the outside temperature. Furthermore, the energy used to increase the SOC of the battery 400 by 1% may change depending on the capacity of the battery 400 applied to the vehicle (e.g., larger-capacity batteries requiring more energy per percentage increase, etc.).

As another example, the processor 500 may compare a charge demand energy, which is an energy required to charge the battery 400 from an initial SOC value to a target SOC value, with a temperature increase demand energy, which is an energy required to increase the temperature of the coolant from an initial temperature value to a target coolant temperature value. The processor 500 may determine one of the temperature increase modes based on whether the value obtained by dividing the energy required to increase temperature by the charge demand energy is within a set range. The processor 500 may distinguish the temperature increase modes based on whether the energy required for coolant heating is similar to the energy required for battery charging (e.g., within a predetermined ratio tolerance, etc.). The case where the energy required to increase temperature is similar to the energy required in charging may correspond to Group 2. Therefore, the set range may be determined by applying a margin value that is predetermined based on a reference ratio of 1. The set range may be determined by applying a margin value derived from a case in which the energy used to increase the SOC of the battery 400 is equal to the energy used to increase the temperature of the coolant.

The temperature increase modes may include a first mode, a second mode, and a third mode. The processor 500 may determine the temperature increase mode as the first mode in response to the value obtained by dividing the temperature increase demand by the charge demand being less than a lower bound of the set range. If the value obtained by dividing the temperature increase demand by the charge demand is less than the lower bound of the set range, this may correspond to Group 1, which indicates that the temperature of the coolant is relatively high with respect to the SOC of the battery 400. That the value obtained by dividing the temperature increase demand by the charge demand is less than the lower bound of the set range may mean that the temperature of the coolant is high with respect to the SOC of the battery 400. The processor 500 may determine the temperature increase mode as the second mode in response to the value obtained by dividing the temperature increase demand by the charge demand falling within the set range. If the value obtained by dividing the temperature increase demand by the charge demand is within the set range, this may correspond to Group 2, which indicates that the temperature of the coolant is balanced or appropriate with respect to the SOC of the battery 400. That the value obtained by dividing the temperature increase demand by the charge demand falls within the set range may mean that the temperature of the coolant is appropriate with respect to the SOC of the battery 400 (e.g., both heating and charging demands are moderately balanced, allowing coordinated operation, etc.). The processor 500 may determine the temperature increase mode as the third mode in response to the value obtained by dividing the temperature increase demand by the charge demand being greater than an upper bound of the set range (e.g., indicating that coolant heating is more urgent than battery charging, such as when ambient temperature is extremely low or the battery is nearly full, etc.). If the value obtained by dividing the temperature increase demand by the charge demand is greater than the upper bound of the set range, this may correspond to Group 3, which indicates that the temperature of the coolant is relatively low with respect to the SOC of the battery 400 (e.g., when the vehicle is parked in subzero conditions while the battery remains highly charged, etc.). This condition may also indicate that the SOC of the battery 400 is high relative to the coolant temperature, such that additional charging is unnecessary while coolant heating is prioritized. That the value obtained by dividing the temperature increase demand by the charge demand is greater than the upper bound of the set range may mean that the temperature of the coolant is relatively low with respect to the SOC of the battery 400 or the SOC of the battery 400 is relatively high with respect to the temperature of the coolant.

The processor 500 may perform temperature control of the fuel cell stack 100 according to one of the temperature increase modes. When the SOC of the battery 400 and the temperature of the coolant correspond to Group 1 and Group 3, the processor 500 may wait for conditions to shift such that the temperature of the coolant to decrease so that the SOC of the battery 400 and the temperature of the coolant fall within Group 2. Alternatively, the processor 500 may drive the COD heater 300 to control the SOC of the battery 400 and the temperature of the coolant.

In the first mode, so as to lower the temperature of the coolant, the processor 500 may stand by without operating the fuel cell stack 100 or the COD heater 300. When no control is performed, the temperature of the coolant, which is higher than the outside temperature, may gradually decrease over time (e.g., due to natural heat dissipation through radiative or convective cooling, etc.). At wake-up, the processor 500 may derive the temperature increase demand and the charge demand based on newly obtained values for the SOC of the battery 400 and the coolant temperature, and may determine whether the value obtained by dividing the temperature increase demand by the charge demand falls within the set range. If the value obtained by dividing the temperature increase demand by the charge demand falls within the set range, the processor 500 may drive the fuel cell stack 100 based on a predetermined output (e.g., a fixed power level, a target current density, or a calibrated warm-up profile, etc.). The predetermined output may vary depending on the current temperature of the coolant and the current SOC of the battery 400. For example, as the temperature of the coolant increases, the predetermined output may decrease, and as the SOC of the battery 400 increases, the predetermined output may decrease. This adjustment may be made to prevent overcharging or overheating (e.g., during partial warm-up or near-full SOC conditions, etc.). However, the upper and lower limits of the predetermined output may be determined in advance (e.g., based on system calibration, hardware constraints, or durability considerations, etc.). Unlike the above-described example, the predetermined output may be set to a fixed value (e.g., a default power level regardless of current state, for simpler control logic, etc.).

In the second mode, the processor 500 may immediately drive the fuel cell stack 100. After the ignition of the vehicle is off, the processor 500 may immediately drive the fuel cell stack 100 upon determining that the value obtained by dividing the temperature increase demand by the charge demand falls within the set range.

In the third mode, the processor 500 may operate the COD heater 300 at the first wake-up. In other words, the processor 500 may stand by without operating the fuel cell stack 100 or the COD heater 300 until the first wake-up. At this time, the temperature of the coolant may decrease and the SOC of the battery 400 may remain constant (e.g., due to the absence of active energy consumption or generation, etc.). As the COD heater 300 is operated at the first wake-up, the SOC of the battery 400 may be decreased and the temperature of the coolant may be increased (e.g., due to electrical energy being converted into thermal energy for coolant heating, etc.). The processor 500 may detect changes in the SOC of the battery 400 and the temperature of the coolant in real time, for example, using sensor feedback and monitoring systems. The processor 500 may derive the temperature increase demand and the charge demand based on newly obtained values for the SOC of the battery 400 and coolant temperature, and may determine whether the value obtained by dividing the temperature increase demand by the charge demand falls within the set range. If the value obtained by dividing the temperature increase demand by the charge demand falls within the set range, the processor 500 may stop driving the COD heater 300 and drive the fuel cell stack 100 based on the predetermined output.

If the temperature of the coolant reaches the target temperature and the SOC of the battery 400 reaches the target SOC, the processor 500 may stop driving the fuel cell stack 100. Thereafter, for CSD control, the processor 500 may control the air compressor 200 to inject air into the fuel cell stack 100 (e.g., to purge residual water and prevent internal freezing, etc.). The air compressor 200 may be driven using the power stored in the battery 400 (e.g., enabling purge cycles to remove residual moisture, etc.).

According to an example of the present disclosure, the timing at which the fuel cell stack 100 is driven may vary depending on the temperature increase modes (e.g., immediate activation in balanced conditions, delayed activation during standby, or post-heating activation after using the COD heater, etc.). Because the timing at which the fuel cell stack 100 is driven is controlled differently depending on corresponding temperature increase modes, unnecessary operation of the COD heater 300 may be prevented (e.g., avoiding redundant heating when simultaneous charging and heating can be achieved by the fuel cell stack, etc.), and the temperature of the coolant and the SOC of the battery 400 may simultaneously reach the target temperature and the target SOC, respectively, by driving the fuel cell stack 100 (e.g., achieving thermal and charge readiness in parallel, etc.). Accordingly, power required in driving the air compressor 200 in the CSD control may be gained during the temperature increase process of the fuel cell stack 100.

According to an example of the present disclosure, the processor 500 may prepare for the CSD in advance control by driving the fuel cell stack 100 to increase the temperature of the coolant and to charge the battery 400 (e.g., ensuring sufficient thermal and electrical readiness before initiating air purge, etc.). Moreover, the processor 500 drives the COD heater 300 only if there is a risk of the battery 400 being overcharged, thereby preventing a situation in which the fuel cell stack 100 is frequently driven at a potential at which deterioration of the fuel cell stack 100 may be accelerated (e.g., below 0.7 V, leading to long-term membrane or catalyst damage, etc.).

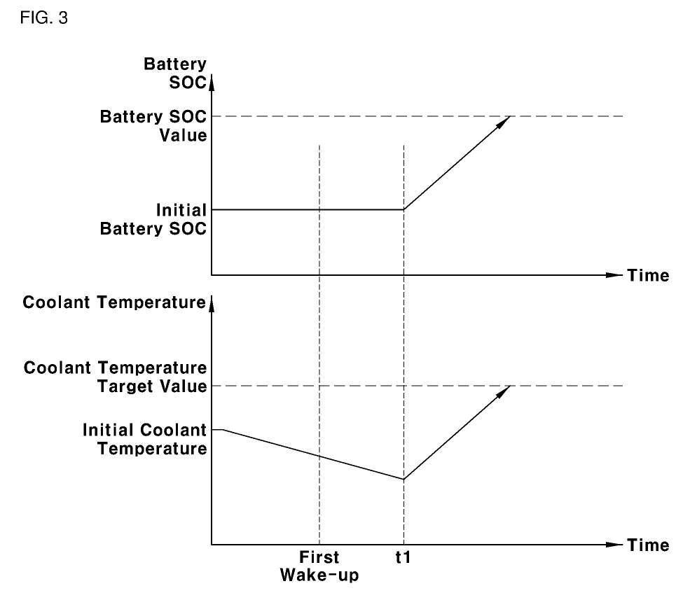

FIG. 3 shows an example of a control method in the first mode according to an example of the present disclosure.

Referring to FIGS. 1 and 3, after the ignition of the vehicle is off, the processor 500 may determine the temperature increase mode as the first mode based on the result of comparing the SOC of the battery 400 with the temperature of the coolant (e.g., when the coolant temperature is relatively high compared to the battery SOC, etc.). For example, the battery SOC target value may be approximately 65%, and the coolant temperature target value may be 65℃, but these may be values that may be adjusted by the designer. Because the temperature of the coolant is relatively higher with respect to the SOC of the battery 400, when the fuel cell stack 100 is driven, the temperature of the coolant may reach the coolant temperature target value, but the SOC of the battery 400 may fail to reach the battery SOC target value (e.g., due to insufficient energy generation duration, etc.). Therefore, the first mode of waiting for the temperature of the coolant to naturally decrease may be performed.

As an example, the processor 500 may derive the charge demand based on the difference between the initial battery SOC and the battery SOC target value (e.g., target SOC of 65% minus initial SOC of 41%). The processor 500 may derive the temperature increase demand based on the difference between the initial coolant temperature and the coolant temperature target value (e.g., target temperature of 65°C minus initial temperature of 55°C). In a case where the difference between the initial coolant temperature and the coolant temperature target value is 10℃, and the difference between the initial battery SOC and the battery SOC target value is 24%, the temperature increase demand may be 10 and the charge demand may be 24. Because the value obtained by dividing the temperature increase demand by the charge demand is less than a lower bound of the set range, the processor 500 may determine the temperature increase mode as the first mode. The set range may be determined based on the value obtained by dividing the energy consumed to increase the temperature of the coolant by 1℃, which is determined by considering the outside temperature, by the energy consumed to increase the SOC of the battery 400 by 1%(e.g., approximately 55–70 kJ/°C for coolant versus 95 kJ/% for SOC, depending on ambient conditions, etc.).

At the first wake-up, the processor 500 may determine whether the value obtained by dividing the temperature increase demand by the charge demand falls within the set range. The processor 500 may reset the coolant temperature target value and the battery SOC target value based on the outside temperature at each wake-up, and may reassess the SOC of the battery 400 and the temperature of the coolant, for example, using updated sensor readings (e.g., from a BMS or temperature sensors, etc.). If the value obtained by dividing the temperature increase demand by the charge demand does not fall within the set range, the processor 500 may reevaluate the value at the next wake-up to determine whether the value falls within the set range (e.g., due to natural cooling or SOC drift during standby, etc.). In other words, the processor 500 may determine whether the temperature of the coolant has dropped to an appropriate temperature at each wake-up.

Based on determining that the value obtained by dividing the temperature increase demand by the charge demand falls within the set range during a wake-up at a first time t1, the processor 500 may drive the fuel cell stack 100. Accordingly, the SOC of the battery 400 may reach the battery SOC target value at the time when the temperature of the coolant reaches the coolant temperature target value (e.g., enabling synchronized fulfillment of thermal and electrical requirements without unnecessary heater activation, etc.). However, if the value obtained by dividing the temperature increase demand by the charge demand at the first wake-up falls within the set range, the processor 500 may also drive the fuel cell stack 100 immediately after the first wake-up. Thus, the first time t1 may also be the first wake-up time point.

According to an example of the present disclosure, if the temperature of the coolant is relatively high with respect to the SOC of the battery 400, the first mode of waiting for the temperature of the coolant to decrease may be performed so that the value obtained by dividing the temperature increase demand based on the temperature of the coolant by the charge demand based on the SOC of the battery 400 falls within the set range. Thereafter, the fuel cell stack 100 may be driven, and the temperature of the coolant and the SOC of the battery 400 may reach their corresponding target values at a similar time (e.g., enabling synchronized completion of both thermal conditioning and battery charging before CSD control, etc.).

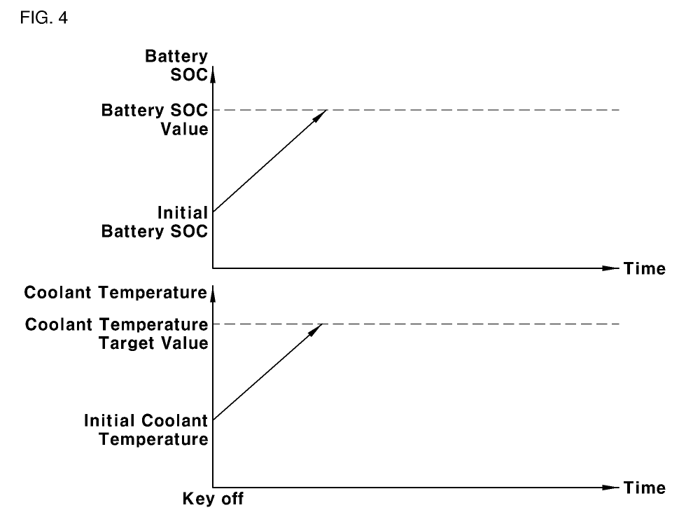

FIG. 4 shows an example of a control method in the second mode according to an example of the present disclosure.

Referring to FIGS. 1 and 4, after the ignition of the vehicle is off, the processor 500 may determine the temperature increase mode as the second mode based on the result of comparing the SOC of the battery 400 with the temperature of the coolant (e.g., when both parameters are balanced such that further heating and charging can be performed simultaneously, etc.).

As an example, when the difference between the initial coolant temperature and the coolant temperature target value is 20℃, and the difference between the initial battery SOC and the battery SOC target value is 12%, the temperature increase demand may be 20 and the charge demand may be 12 (e.g., coolant at 45℃ with a target of 65℃, and SOC at 53% with a target of 65%, etc.). Because the value obtained by dividing the temperature increase demand by the charge demand is within the set range (e.g., between 1.07 and 1.875, etc.), the processor 500 may determine the temperature increase mode as the second mode. Because the temperature of the coolant is determined to be appropriate with respect to the SOC of the battery 400 (e.g., both values falling within a range enabling simultaneous heating and charging, etc.), the processor 500 may immediately drive the fuel cell stack 100. The processor 500 may complete the driving of the fuel cell stack 100 and the CSD control after the ignition of the vehicle is off and before the first wake-up.

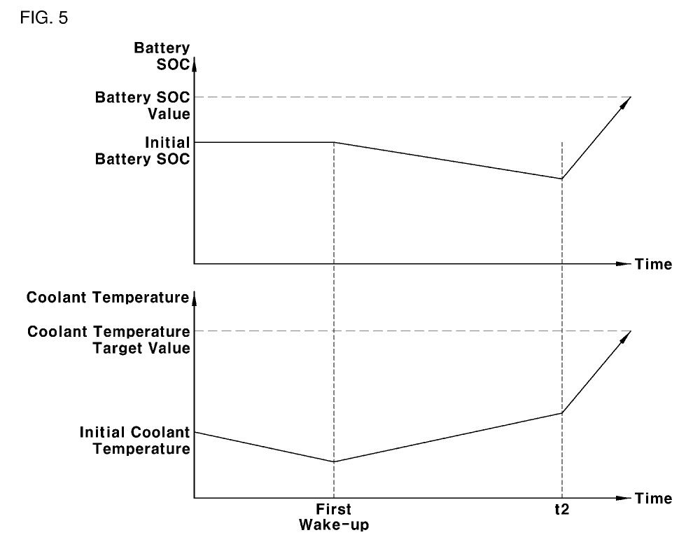

FIG. 5 shows an example of a control method in the third mode according to an example of the present disclosure.

Referring to FIGS. 1 and 5, after the ignition of the vehicle is off, the processor 500 may determine the temperature increase mode as the third mode based on the result of comparing the SOC of the battery 400 with the temperature of the coolant. Because the temperature of the coolant is low with respect to the SOC of the battery 400, when the fuel cell stack 100 is driven, the SOC of the battery 400 may reach the battery SOC target value, but the temperature of the coolant may not reach the coolant temperature target value (e.g., SOC reaches 65% while coolant temperature remains below 50°C, etc.). Therefore, the third mode of increasing the temperature of the coolant and decreasing the SOC of the battery 400 through the COD heater 300 may be performed (e.g., to avoid overcharging the battery while meeting coolant heating needs, etc.).

As an example, the processor 500 may derive the charge demand based on the difference between the initial battery SOC and the battery SOC target value (e.g., if the initial SOC is 50% and the target SOC is 65%, the charge demand is 15%). The processor 500 may derive the temperature increase demand based on the difference between the initial coolant temperature and the coolant temperature target value (e.g., if the initial coolant temperature is 30°C and the target temperature is 65°C, the temperature increase demand is 35°C). When the difference between the initial coolant temperature and the coolant temperature target value is 45℃ (e.g., initial coolant temperature of 20°C and target of 65°C), and the difference between the initial battery SOC and the battery SOC target value is 12% (e.g., initial SOC of 53% and target of 65%), the temperature increase demand may be 45 and the charge demand may be 12. Because the value obtained by dividing the temperature increase demand by the charge demand is greater than an upper bound of the set range, the processor 500 may determine the temperature increase mode as the third mode.

Before the first wake-up, the fuel cell stack 100 and the COD heater 300 may not be driven. In other words, the third mode may be a standby mode in which both the fuel cell stack 100 and the COD heater 300 are not driven until the first wake-up (e.g., to prevent unnecessary energy consumption, avoid potential overcharging, or mitigate stack degradation under suboptimal conditions, etc.). At the first wake-up, the processor 500 may drive the COD heater 300 until a second time t2, which corresponds to a point at which the ratio of the temperature increase demand to the charge demand falls within the set range. The second time t2 may be a specific time within a period during which the processor 500 is activated according to the first wake-up. In other words, the processor 500 may drive the COD heater 300 until the SOC of the battery 400 is decreased to an appropriate level with respect to the temperature of the coolant or until the temperature of the coolant is increased to an appropriate level with respect to the SOC of the battery 400. The processor 500 may stop driving the COD heater 300 and drive the fuel cell stack 100 if the ratio of the temperature increase demand to the charge demand falls within the set range. As the fuel cell stack 100 is driven, increasing of the coolant temperature and charging of the battery 400 may be simultaneously performed (e.g., maintaining optimal stack durability and system efficiency, etc.). Driving of the COD heater 300 and driving of the fuel cell stack 100 both may be performed after the first wake-up and before the next wake-up (e.g., during the active period following the first wake-up and prior to the next scheduled wake-up cycle). In other words, both the driving of the COD heater 300 and the driving of the fuel cell stack 100 may be performed within the activation time of the processor 500 after the first wake-up.

According to an example of the present disclosure, if the temperature of the coolant is relatively low with respect to the SOC of the battery 400, the second mode of driving the COD heater 300 to increase the temperature of the coolant is performed so that the value obtained by dividing the temperature increase demand by the charge demand may fall within a set range. Thereafter, the fuel cell stack 100 is driven, and the temperature of the coolant and the SOC of the battery 400 may reach corresponding target values at a similar time (e.g., within a predefined tolerance band, during the same activation window, or by a scheduled completion time, etc.).

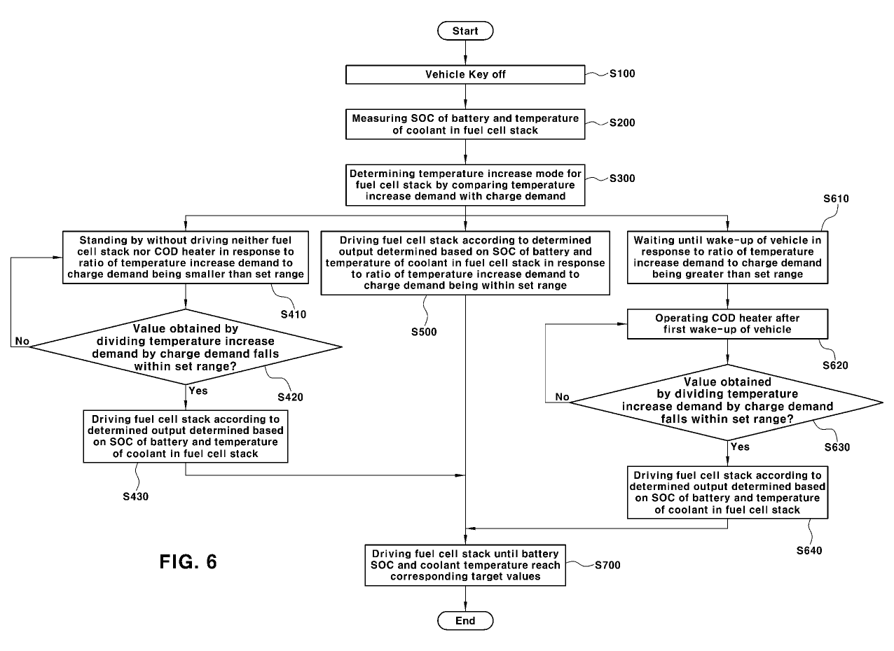

FIG. 6 shows an example of a method for controlling the temperature of the coolant in the fuel cell stack according to an example of the present disclosure.

Referring to FIGS. 1 and 6, after the ignition off (KEY OFF) of a vehicle, which includes a vehicle, such as a passenger car, a commercial truck, a drone, or an unmanned ground vehicle, etc., the processor 500 may receive information on the SOC of the battery 400 and information on measurement of the temperature of the coolant in the fuel cell stack 100. The processor 500 may maintain the activated state for a predetermined time after the ignition off (KEY OFF) (S100 and S200).

The processor 500 may compare the temperature increase demand derived based on the temperature of the coolant in the fuel cell stack 100 with the charge demand derived based on the SOC of the battery 400. The processor 500 may determine temperature increase modes of the fuel cell stack 100 based on the result of comparing the ratio of the temperature increase demand to the charge demand with a predetermined set range. The temperature increase modes may be divided into a mode of immediately driving the fuel cell stack 100 after the ignition of the vehicle is off (e.g., when both the coolant temperature and SOC are below targets) and a mode of driving the fuel cell stack 100 after the wake-up of the vehicle (e.g., when waiting for the coolant temperature to drop or preheating via a heater is required). The mode of driving the fuel cell stack 100 after the wake-up of the vehicle may be divided into a mode of driving the COD heater 300 and a mode of not driving the COD heater 300 (e.g., depending on battery SOC, coolant temperature, or system degradation risk, etc.). The temperature increase modes of the fuel cell stack 100 may be divided into the first mode, the second mode, and the third mode (e.g., a standby mode without driving the heater or stack, an immediate driving mode of the stack, and a delayed driving mode with prior heater activation, respectively). The mode of driving the fuel cell stack 100 immediately after the ignition of the vehicle is off may be the second mode (e.g., used when the coolant temperature and battery SOC are balanced to allow immediate simultaneous heating and charging without preliminary adjustments). The mode of driving the fuel cell stack 100 but not driving the COD heater 300 after the wake-up of the vehicle may be the first mode (e.g., when the coolant temperature is relatively high compared to the SOC of the battery 400, allowing time for natural cooling). The mode of driving the fuel cell stack 100 after the wake-up of the vehicle but driving the COD heater 300 first may be the third mode (S300) (e.g., when the coolant temperature is too low relative to the SOC, requiring preheating before simultaneous fuel cell operation).

If the ratio of the temperature increase demand to the charge demand is smaller than the set range, the processor 500 may perform a temperature increase of the fuel cell stack 100 in the first mode. The processor 500 may stand by without driving either the fuel cell stack 100 or the COD heater 300 until the ratio of the temperature increase demand to the charge demand falls within the set range. Because neither the fuel cell stack 100 nor the COD heater 300 is driven, the temperature of the coolant may gradually be decreased due to the low outside temperature (S410) (e.g., in winter conditions, nighttime parking, or cold storage scenarios).

The processor 500 may determine whether the value obtained by dividing the temperature increase demand by the charge demand falls within the set range at each wake-up. If it is determined that the value obtained by dividing the temperature increase demand by the charge demand does not fall within the set range, the processor 500 may reevaluate whether the value obtained by dividing the temperature increase demand by the charge demand falls within the set range at the next wake-up without driving either the fuel cell stack 100 or the COD heater 300 (S420) (e.g., passive cooling continues due to ambient temperature exposure).

If the value obtained by dividing the temperature increase demand by the charge demand increases and falls within the set range, the processor 500 may drive the fuel cell stack 100 according to a determined output. The determined output may change based on the SOC of the battery 400 and the temperature of the coolant at the time when driving of the fuel cell stack 100 (S430) begins (e.g., higher coolant temperature or higher SOC may reduce the output level).

If the ratio of the temperature increase demand to the charge demand falls within the set range, the processor 500 may perform a temperature increase of the fuel cell stack 100 in the second mode. The processor 500 may drive the fuel cell stack 100 according to a determined output determined based on the SOC of the battery 400 and the temperature of the coolant at the time of ignition off (S500).

If the ratio of the temperature increase demand to the charge demand is greater than an upper boundary of the set range, the processor 500 may perform a temperature increase of the fuel cell stack 100 in the third mode. The processor 500 may stand by without driving either the fuel cell stack 100 or the COD heater 300 until the wake-up of the vehicle (S610) (e.g., early morning startup in extremely cold climates).

After the first wake-up, the processor 500 may drive the COD heater 300. Because the fuel cell stack 100 and the COD heater 300 are not operated before the first wake-up, the temperature of the coolant at the time of the first wake-up may be decreased compared to the time of ignition off (S620) (e.g., due to overnight ambient cooling).

The processor 500 may drive the COD heater 300 until the ratio of the temperature increase demand to the charge demand decreases and falls within the set range. Here, the processor 500 may continuously determine the ratio of the temperature increase demand to the charge demand (S630) (e.g., every second or based on a sensor polling interval).

If the ratio of the temperature increase demand to the charge demand falls within the set range, the processor 500 may stop operating the COD heater 300 and start operating the fuel cell stack 100 based on a determined output. Here, the determined output may be determined based on the SOC of the battery 400 and the temperature of the coolant at the time when the driving of the COD heater 300 is stopped or the driving of the fuel cell stack 100 is started (S640).

The processor 500 may operate the fuel cell stack 100 until both the SOC of the battery 400 reaches a target value and the temperature of the coolant reaches a target value. Because the fuel cell stack 100 is driven if the ratio of the temperature increase demand to the charge demand falls within the set range, the SOC of the battery 400 and the temperature of the coolant may reach corresponding target values at a similar time. Therefore, as the temperature of the coolant and the SOC of the battery 400 each reach the corresponding target value, the output of the battery 400 required in the CSD control performed thereafter may be secured and freezing of the generated water in the fuel cell stack 100 may be prevented (e.g., under sub-zero external temperatures during winter startup, etc.).

Unlike the above-described example, the processor 500 may determine the temperature increase mode based on the ratio of energy value, rather the ratio of the temperature increase demand to the charge demand. Specifically, the processor 500 may use the ratio of the temperature increase demand energy (the energy required to raise the temperature of the coolant in the fuel cell stack 100 to the coolant temperature target value) to the charge demand energy, which is the energy required to charge the battery 400 until the SOC of the battery 400 reaches the SOC target value.

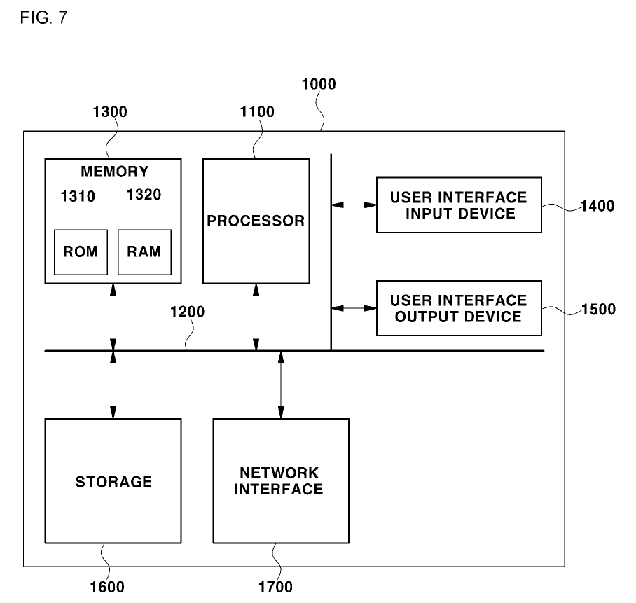

FIG. 7 shows an example computing system (e.g., a computing device of a fuel cell system, a processor, a vehicle, any other apparatus). One or more controllers, processors, etc. described herein, such as one or more components of a fuel cell system, one or more components of a processor, one or more components of a vehicle, and any other components and devices disclosed herein, may be implemented by or in the computing system as shown in FIG. 7.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

In one example, the present disclosure provides an apparatus for controlling the temperature of a coolant in a fuel cell stack. The apparatus includes the fuel cell stack and a processor configured to control the fuel cell stack, wherein the processor may control a mode of increasing a temperature of the fuel cell stack after an ignition of a vehicle equipped with the fuel cell stack is off, the processor may determine any one of a plurality of temperature increase modes of the fuel cell stack based on a state of charge (SOC) of a battery mounted on the vehicle and the temperature of the coolant in the fuel cell stack, and the temperature increase modes may include a mode using a cathode oxygen depletion (COD) heater and a mode not using the COD heater.

In an example of the present disclosure, the processor may determine any one of the temperature increase modes by comparing a ratio of a temperature increase demand, which is a difference between the temperature of the coolant and a target temperature, to a charge demand, which is a difference between the SOC of the battery and a target SOC, with a set range.

In another example of the present disclosure, the processor may determine the temperature increase mode as a first mode based on the ratio of the temperature increase demand to the charge demand being smaller than the set range, the processor may determine the temperature increase mode as a second mode based on the ratio of the temperature increase demand to the charge demand being within the set range, and the processor may determine the temperature increase mode as a third mode based on the ratio of the temperature increase demand to the charge demand being greater than the set range.

In yet another example of the present disclosure, in the first mode, the processor may stand by until the ratio of the temperature increase demand to the charge demand enters the set range, before driving the fuel cell stack.

In yet another example of the present disclosure, the processor may determine whether the ratio of the temperature increase demand to the charge demand enters the set range every time a wake-up of the vehicle occurs, and the processor may drive the fuel cell stack in response to the ratio of the temperature increase demand to the charge demand entering the set range.

In still yet another example of the present disclosure, in the second mode, the processor may drive the fuel cell stack to increase the temperature of the coolant and to charge the battery.

In a further example of the present disclosure, in the third mode, the processor may drive the COD heater, before driving the fuel cell stack, to increase the temperature of the coolant.

In another further example of the present disclosure, in response to the ratio of the temperature increase demand to the charge demand entering the set range, the processor may stop driving the COD heater and to drive the fuel cell stack.

In yet another further example of the present disclosure, the processor may compare a charge demand energy, which is an energy required to charge the battery until the SOC of the battery reaches a target SOC, with a temperature increase demand energy, which is an energy required to increase the temperature of the coolant until the temperature of the coolant reaches a target temperature, to determine any one of the plurality of temperature increase modes in which a timing of driving the fuel cell stack varies, and the temperature increase demand energy may be a product of a temperature increase demand, which is a difference between the temperature of the coolant and the target temperature, and a heat capacity of the coolant, which varies depending on outside temperature.

In another example, the present disclosure provides a vehicle. The vehicle includes a fuel cell stack configured to generate power, a battery being charged by the power generated by the fuel cell stack, and a processor configured to control a mode of increasing a temperature of the fuel cell stack after an ignition of a vehicle equipped with the fuel cell stack is off. Here, the processor may determine one of a plurality of temperature increase modes of the fuel cell stack based on a state of charge (SOC) of the battery mounted on the vehicle and a temperature of a coolant in the fuel cell stack, and the temperature increase modes may include a first mode of waiting until a wake-up of the vehicle, a second mode of driving the fuel cell stack, and a third mode of operating a cathode oxygen depletion (COD) heater.

In an example of the present disclosure, the mode of increasing the temperature of the fuel cell stack may be performed before a cold shut down (CSD) control in which air is supplied to discharge droplets remaining in the fuel cell stack.

In another example of the present disclosure, the processor may determine any one of the temperature increase modes by comparing a ratio of a temperature increase demand, which is a difference between the temperature of the coolant and a target temperature, to a charge demand, which is a difference between the SOC of the battery and a target SOC, with a set range, in the first mode, the processor may drive the fuel cell stack in response to the ratio of the temperature increase demand to the charge demand entering the set range, and in the third mode, the processor may stop driving the COD heater and drive the fuel cell stack in response to the ratio of the temperature increase demand to the charge demand entering the set range.

In yet another example of the present disclosure, the processor may drive the fuel cell stack based on outputs varying depending on the SOC of the battery and the temperature of the coolant according to the temperature increase modes.

In still another example, the present disclosure provides a method for controlling a temperature of a coolant in a fuel cell stack. The method includes analyzing, by a processor, an SOC of a battery and a temperature of a coolant in the fuel cell stack after an ignition of a vehicle equipped with the fuel cell stack is off, determining, by the processor, any one of a plurality of temperature increase modes of the fuel cell stack based on the SOC of the battery and the temperature of the coolant in the fuel cell stack, and controlling, by the processor, to drive the fuel cell stack or to stand by without driving the fuel cell stack and a COD heater until a wake-up of the vehicle depending on each of the temperature increase modes.

In an example of the present disclosure, the determining any one of the plurality of temperature increase modes of the fuel cell stack may include determining any one of the plurality of temperature increase modes depending on whether a ratio of a temperature increase demand, which is a difference between a temperature of a coolant and a target temperature, to a charge demand, which is a difference between a SOC of the battery and a target SOC falls within a set range.

In another example of the present disclosure, the temperature increase modes may include a first mode of, based on the ratio of the temperature increase demand to the charge demand being smaller than the set range, waiting without driving the fuel cell stack and the COD heater until the ratio of the temperature increase demand to the charge demand reaches the set range.

In yet another example of the present disclosure, the temperature increase modes may include a second mode of immediately driving the fuel cell stack and the COD heater based on the ratio of the temperature increase demand to the charge demand being within the set range.

In yet another example of the present disclosure, the temperature increase modes may include a third mode of, based on the ratio of the temperature increase demand to the charge demand being greater than the set range, driving the COD heater until the ratio of the temperature increase demand to the charge demand reaches the set range.

In still yet another example of the present disclosure, the third mode may include driving the COD heater after a first wake-up of the vehicle, and, based on the ratio of the temperature increase demand to the charge demand reaching the set range, stopping driving the COD heater and driving the fuel cell stack.

In a further example of the present disclosure, the temperature increase modes may be divided into a mode of driving the fuel cell stack immediately after the ignition of the vehicle is off and a mode of driving the fuel cell stack after a wake-up of the vehicle. Here, the mode of driving the fuel cell stack after the wake-up of the vehicle may be divided into a mode of driving the COD heater and a mode of not driving the COD heater.

It is to be understood that the term “vehicle” or “vehicular” or other similar terms as used herein are inclusive of motor vehicles in general, such as passenger vehicles including sports utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

As is apparent from the above description, the present disclosure provides the following effects.

According to an example of the present disclosure, because the timing at which the fuel cell stack is driven varies depending on the corresponding temperature increase modes, unnecessary operation of the COD heater may be prevented, and the coolant temperature and the battery SOC may simultaneously reach the target temperature and the target SOC, respectively, by driving the fuel cell stack. Therefore, power required in driving the air compressor in the CSD control may be gained during the temperature increase process of the fuel cell stack.

According to an example of the present disclosure, the processor may prepare for the CSD control by driving the fuel cell stack to increase the temperature of the coolant and to charge the battery. Moreover, the processor drives the COD heater only if there is a risk of the battery being overcharged, thereby preventing a situation in which the fuel cell stack is frequently driven at a potential at which deterioration of the fuel cell stack may be accelerated, preventing deterioration of the durability of the COD heater and fuel cell stack.

In the above, examples of the present disclosure have been described with reference to the accompanying drawings. However, those skilled in the art to which the present disclosure pertains will understand that the present disclosure may be embodied in other specific forms without changing the technical idea or essential features thereof. Therefore, it should be understood that the examples described above are illustrative in all respects and not restrictive.

What is claimed is:

1. An apparatus of a vehicle, the apparatus comprising:
a fuel cell stack;
a processor; and
a memory storing at least one instruction that, when executed by the processor communicating with the memory, is configured to cause the apparatus to:
after an ignition of the vehicle equipped with the fuel cell stack is off, determine, based on a state of charge (SOC) of a battery mounted on the vehicle and a temperature of a coolant in the fuel cell stack, one of a plurality of temperature increase modes of the fuel cell stack, wherein the plurality of temperature increase modes comprise a mode using a cathode oxygen depletion (COD) heater and a mode not using the COD heater, and
control, based on the determined one of the plurality of temperature increase modes, the temperature of the coolant in the fuel cell stack.

2. The apparatus of claim 1, wherein the at least one instruction, when executed by the processor communicating with the memory, is configured to cause the apparatus to determine one of the plurality of temperature increase modes by comparing a ratio of a temperature increase demand to a charge demand with a set range, wherein the temperature increase demand is a difference between the temperature of the coolant and a target temperature, and wherein the charge demand is a difference between the SOC of the battery and a target SOC.

3. The apparatus of claim 2, wherein the at least one instruction, when executed by the processor communicating with the memory, is configured to cause the apparatus to:
determine one of the plurality of temperature increase modes as a first mode based on the ratio of the temperature increase demand to the charge demand being less than a lower boundary of the set range,
determine one of the plurality of temperature increase modes as a second mode based on the ratio of the temperature increase demand to the charge demand being within the set range, and
determine one of the plurality of temperature increase modes as a third mode based on the ratio of the temperature increase demand to the charge demand being greater than an upper boundary of the set range.

4. The apparatus of claim 3, wherein, in the first mode, the at least one instruction, when executed by the processor communicating with the memory, is configured to cause the apparatus to stand by until the ratio of the temperature increase demand to the charge demand enters the set range, before operating the fuel cell stack.

5. The apparatus of claim 4, wherein the at least one instruction, when executed by the processor communicating with the memory, is configured to cause the apparatus to:
determine whether the ratio of the temperature increase demand to the charge demand enters the set range every time a wake-up of the vehicle occurs, and
operate the fuel cell stack based on the ratio of the temperature increase demand to the charge demand entering the set range.

6. The apparatus of claim 3, wherein, in the second mode, the at least one instruction, when executed by the processor communicating with the memory, is configured to cause the apparatus to:
operate the fuel cell stack to increase the temperature of the coolant, and
charge the battery.

7. The apparatus of claim 3, wherein, in the third mode, the at least one instruction, when executed by the processor communicating with the memory, is configured to cause the apparatus to operate the COD heater, before operating the fuel cell stack, to increase the temperature of the coolant.

8. The apparatus of claim 7, wherein, based on the ratio of the temperature increase demand to the charge demand entering the set range, the at least one instruction, when executed by the processor communicating with the memory, is configured to cause the apparatus to:
stop operating the COD heater, and
operate the fuel cell stack.

9. The apparatus of claim 1, wherein the at least one instruction, when executed by the processor communicating with the memory, is configured to cause the apparatus to:
compare a charge demand energy with a temperature increase demand energy to determine one of the plurality of temperature increase modes in which a timing of operating the fuel cell stack varies, wherein the charge demand energy is an energy used to charge the battery until the SOC of the battery reaches a target SOC, wherein the temperature increase demand energy is an energy used to increase the temperature of the coolant until the temperature of the coolant reaches a target temperature, and wherein the temperature increase demand energy is a product of a temperature increase demand and a heat capacity of the coolant, wherein the temperature increase demand is a difference between the temperature of the coolant and the target temperature, and wherein the heat capacity of the coolant varies based on outside temperature of the fuel cell stack.

10. A vehicle comprising:
a fuel cell stack configured to generate power;
a battery configured to be charged by the power generated by the fuel cell stack;
a processor; and
a memory storing at least one instruction that, when executed by the processor communicating with the memory, is configured to cause the vehicle to:
after an ignition of the vehicle is off, determine, based on a state of charge (SOC) of the battery and a temperature of a coolant in the fuel cell stack, one of a plurality of temperature increase modes of the fuel cell stack, wherein the temperature increase modes comprise a first mode of waiting until a wake-up of the vehicle, a second mode of operating the fuel cell stack, and a third mode of operating a cathode oxygen depletion (COD) heater, and
control, based on the determined one of the plurality of temperature increase modes, the temperature of the coolant in the fuel cell stack.

11. The vehicle of claim 10, wherein the at least one instruction, when executed by the processor communicating with the memory, is configured to cause the vehicle to control, based on the determined one of the plurality of temperature increase modes, the temperature of the coolant in the fuel cell stack before a cold shut down (CSD) control in which air is supplied to discharge droplets remaining in the fuel cell stack.

12. The vehicle of claim 10, wherein the at least one instruction, when executed by the processor communicating with the memory, is configured to cause the vehicle to:
determine one of the temperature increase modes by comparing a ratio of a temperature increase demand to a charge demand with a set range, wherein the temperature increase demand is a difference between the temperature of the coolant and a target temperature, and wherein the charge demand is a difference between the SOC of the battery and a target SOC,
in the first mode, operate the fuel cell stack based on the ratio of the temperature increase demand to the charge demand entering the set range, and
in the third mode, stop operating the COD heater and operate the fuel cell stack based on the ratio of the temperature increase demand to the charge demand entering the set range.

13. The vehicle of claim 10, wherein the at least one instruction, when executed by the processor communicating with the memory, is configured to cause the vehicle to operate the fuel cell stack at an output level that varies based on the SOC of the battery and the temperature of the coolant.

14. A method performed by an apparatus of a vehicle, the method comprising:
obtaining information about a state of charge (SOC) of a battery of the vehicle and a temperature of a coolant in a fuel cell stack of the vehicle after an ignition of the vehicle is off;
determining, based on the information about the SOC of the battery and the temperature of the coolant in the fuel cell stack, one of a plurality of temperature increase modes of the fuel cell stack; and
based on the determining of the one of the plurality of temperature increase modes, performing one of:
operating the fuel cell stack, or
standing by without operating the fuel cell stack and a cathode oxygen depletion (COD) heater until a wake-up of the vehicle.

15. The method of claim 14, wherein the determining of one of the plurality of temperature increase modes of the fuel cell stack comprises:
determining one of the plurality of temperature increase modes based on whether a ratio of a temperature increase demand to a charge demand falling within a set range, wherein the temperature increase demand is a difference between a temperature of a coolant and a target temperature, and wherein the charge demand is a difference between a SOC of the battery and a target SOC.

16. The method of claim 15, wherein the plurality of temperature increase modes comprise a first mode in which, based on the ratio of the temperature increase demand to the charge demand being less than a lower boundary of the set range, waiting is performed without operating the fuel cell stack and the COD heater until the ratio of the temperature increase demand to the charge demand reaches the set range.

17. The method of claim 15, wherein the plurality of temperature increase modes comprise a second mode in which, based on the ratio of the temperature increase demand to the charge demand being within the set range, operating the fuel cell stack and operating the COD heater are performed without delay after the ignition of the vehicle is off.

18. The method of claim 15, wherein the plurality of temperature increase modes comprise a third mode in which, based on the ratio of the temperature increase demand to the charge demand being greater than an upper boundary of the set range, the COD heater is operated until the ratio of the temperature increase demand to the charge demand reaches the set range.

19. The method of claim 18, wherein, in the third mode:
driving the COD heater is performed after a first wake-up of the vehicle; and
based on the ratio of the temperature increase demand to the charge demand reaching the set range, the COD heater is stopped and the fuel cell stack is operated.

20. The method of claim 14, wherein the plurality of temperature increase modes comprises:
a mode of operating the fuel cell stack without delay after the ignition of the vehicle is off, and
a mode of operating the fuel cell stack after a wake-up of the vehicle,
wherein the mode of driving the fuel cell stack after the wake-up of the vehicle comprises a mode of operating the COD heater and a mode of not operating the COD heater.
